(19) United States
(12) Patent Application Publication
(10) Pub. No.: US 2005/0012563 A1
(43) Pub. Date: Jan. 20, 2005

(54) Method and system for the simulataneous recording and identification of audio-visual material

(76) Inventor: Michael Kramer, Yonkers, NY (US)

Correspondence Address: Abigail F. Cousins, Esq., 50 Ashton Road, Yonkers, NY, 10705, US

(21) Appl. No.: 10/620,648

(22) Filed: Jul. 16, 2003

(51) Int. Cl. H01P 5/12

(52) U.S. Cl. 333/125

(57) ABSTRACT

For recording selected content for later playback from a broadcast, a recording process records at least one content item for later playback, identifying that content item using its content and storing a respective item identifier indicative of the content item for that content item.

### BACKGROUND OF THE INVENTION

Internet webcasting of digital material has become widespread. As described by the United States Copyright Office:

In 1995, Congress enacted the Digital Performance Right in Sound Recordings Act (“DPRA”), Public Law 104-39, which created an exclusive right for copyright owners of sound recordings, subject to certain limitations, to perform publicly their sound recordings by means of certain digital audio transmissions. Among the limitations on the performance right was the creation of a new compulsory license for nonexempt, noninteractive, digital subscription transmissions. 17 U.S.C. 114(f).

The scene of this license was expanded in 1998 upon passage of the Digital Millennium Copyright Act of 1998 (“DMCA” or “Act”), Public Law 105-304, in order to allow a nonexempt eligible nonsubscription transmission (the “webcasting license”) and a nonexempt transmission by a preexisting satellite digital audio radio service to perform publicly a sound recording in accordance with the terms and rates of the statutory license. The law is enacted in “17 U.S.C. 114(a)”.

The rates for webcasting are described in:
http://www.copyright.gov/carp/webcasting_rates.html.

The creation of this compulsory license means that webcasting services which meet the conditions of the compulsory license do not have to secure permission from all of the copyright holders of the broadcast material. Rather, the owners of the copyright material are required to license all copyright content for Internet broadcast provided that the broadcaster meets the requirements and pays set royalty payments to a clearing house designated by the Copyright Office.

Some of the conditions of the compulsory license are that:
“(ii) the transmitting entity does not cause to be published, or induce or facilitate the publication, by means of an advance program schedule or prior announcement, the titles of the specific sound recordings to be transmitted, the phonorecords embodying such sound recordings, or, other than for illustrative purposes, the names of the featured recording artists . . . .
(v) the transmitting entity cooperates to prevent, to the extent feasible without imposing substantial costs or burdens, a transmission recipient or any other person or entity from automatically scanning the transmitting entity's transmissions alone or together with transmissions by other transmitting entities in order to select a particular sound recording to be transmitted to the transmission recipient, except that the requirement of this clause shall not apply to a satellite digital audio service that is in operation, or that is licensed by the Federal Communications Commission, on or before Jul. 31, 1998;
(vi) the transmitting entity takes no affirmative steps to cause or induce the making of a phonorecord by the transmission recipient, and if the technology used by the transmitting entity enables the transmitting entity to limit the making by the transmission recipient of phonorecords of the transmission directly in a digital format, the transmitting entity sets such technology to limit such making of phonorecords to the extent permitted by such technology;”

The effect of this legislation is to allow the broadcaster to send out digital transmissions of copyrighted content without the need to secure an explicit license, provided that: (a) there be no published advance program or advance catalog of transmitted material, (b) he should not encourage and should attempt to prevent the scanning of the transmission by the receiver for the purpose of selecting a particular recording to be transmitted, and (c) the broadcaster may not facilitate the recording of the material by the recipient.

Copyright law and legal precedent allow the receiver of copyrighted material to exercise “fair use” rights over the material. The “fair use” doctrine is a public domain exclusion to the copyright law. It is beyond the scope of this write-up to delineate the parameters of allowable fair use (see http://www.eff.org/IP/eff_fair_use_faq.html), but this principle is behind the decision of the Supreme Court in 1984 to allow the public the right to use a VCR to “time shift” the viewing of program material.

Many Internet Broadcast services are available on the Web. Some are offered free, such as AOL/Netscape's Radio Netscape Plus, some are subscription services, such as Real Network's Real One service, Listen.com's Rhapsody (Rhapsody is presently being acquired by Real), or Pressplay by Universal and Sony (soon to be acquired by Roxio). Many of these subscription services offer two options: a) a subscriber can listen to the music of choice while connected to the Internet, or b) a subscriber can “burn” or transfer the music to some local storage (it could be a CD, the computer disk drive or a portable music player with built-in storage). These options are severely limiting, and based on the 1984 Supreme Court Betamax decision, it is permissible for someone who receives these broadcasts to record them for later listening under conditions most favorable to the listener, such as in the car or at a later time when not connected to the Internet or not in front of a personal computer.

### OBJECTS AND SUMMARY OF THE INVENTION

The present invention provides a method and system which are intended and designed to overcome the above-discussed limitations of the prior art.

A specific purpose of this invention is to provide a mechanism for the public to receive Internet Webcast material broadcast from a server to a client device and to record it for later listening, without any involvement of the broadcaster. More generally, the purpose of this invention is to provide a mechanism for the public to receive material broadcast from any program to the client device to record it for later listening without any involvement of the broadcaster. In over the air broadcast of television material, this has been deemed by the courts to be a fair use of the content. In the case of the Video Cassette Recorder (VCR), or the Digital Video Recorder (DVR) such as the TIVO, time deferred recording of specific content is facilitated by the availability of a program guide. In the case of Internet Webcasting, the terms of the compulsory license make it impossible for the broadcaster to make available a program guide.

Thus, in accordance with one preferred embodiment of the invention, a system for recording selected broadcasted audio and/or video content for later playback comprises a receiver for receiving, in a receiving process, a data stream that has been broadcast from a program source, the stream including a plurality of content items, and a recorder, connected to receive the data stream from the receiver, for recording, in a recording process, at least one of the content items for later playback. In accordance with an advantageous aspect of the present invention, for each content item recorded by the recorder, the recording process uses the content of that content item to identify that content item as part of the process of its recordation and stores a respective item identifier indicative of the respective content for that content item.

As a result of this structure, any recorded content item is selectable for playback based upon its respective item identifier independently of any other recorded content item.

In accordance with another preferred embodiment of the invention, a system for recording selected broadcasted audio and/or video content for later playback comprises a receiver for receiving, in a receiving process, a data stream that has been webcast from a server, the stream including a plurality of content items, and a recorder, connected to receive the data stream from the receiver, for recording, in a recording process independent of the receiving process, at least one of the content items for later playback. In accordance with an advantageous aspect of the present invention, for each content item recorded by the recorder, the recording process uses the content of that content item to identify that content item and stores a respective item identifier indicative of the respective content for that content item. Again, any recorded content item is selectable for playback based upon its respective item identifier independently of any other recorded content item.

In a preferred aspect, the recorder is recorder software installed in the apparatus.

In another embodiment, the present invention is directed to methods for carrying out these functions.

These and other objects, features and advantages of the present invention will be made apparent from the following detailed description of the preferred embodiments taken in conjunction with the attached drawings.

### BRIEF DESCRIPTION OF THE DRAWINGS

The invention will be further described with reference to the drawings in which like elements are represented by the same number.

FIG. 1 is an illustration of the structure of an apparatus in accordance with a preferred embodiment of the present invention.

FIG. 2 is an illustration of a recording process in accordance with the present invention.

FIG. 3 is an illustration of a playback process in accordance with the present invention.

FIG. 4 is an illustration of an advantageous user interface employable in accordance with the present invention.

### DETAILED DESCRIPTION OF THE PREFERRED EMBODIMENTS

The key parts of this invention are the combination of a two-fold process. This process will be described herein primarily in terms of receiving, recording and playing back audio content items webcast from a server, but it will be understood that the present invention also applies to other types of content and other broadcasters, including traditional radio and television broadcasting systems.

First, the invention is embodied in a process for recording the received audio stream without the involvement of the broadcaster. That is, recording should be performed solely by the receiver without the broadcaster's facilitation, being that such facilitation would violate the terms of the broadcaster's license. Moreover, the recording process should be separate from the process of receiving the broadcast, and thus technologically impossible for the broadcaster to prevent and solely in the province of the user to use.

Second, the recorder should provide a mechanism for selectively recording specific program material. This mimics the ability of the VCR or the DVR to record specific programs. Because program guides cannot be disseminated by the Webcaster, again the selection of recorded material must be done without the participation or cooperation of the broadcaster.

The separation of the recording system from the Internet broadcast system is made possible by the design of the modern computer. When the computer was initially invented, the hardware and the Operating System were very tightly bound together. The behavior of these early computers was such that a program which made use of hardware functions such as sending output to the audio speaker or sending output to the video screen was in full control of these hardware components. In the vernacular it was said that “the programmers talked directly to the hardware.” Modern computers are built with Operating Systems that do not allow any program to have direct control over the hardware. Rather, the Operating System includes a software component called a “driver” which acts as an abstract software representation of the hardware. When a program wishes to send output to an audio component, the program sends out information in a specified format to the Application Programming Interface (API) of the driver, and the driver in turn processes that information, and the driver eventually controls the hardware itself. Drivers can be written by anyone, as long as they conform to the driver technical specifications. Not every driver has to directly control the hardware. Drivers can also be written so as to be intermediaries in a cascade of drivers. A monolithic device, such as an MP3 player, can be built using the same architecture.

Using this architecture of the modern computer, the Internet Broadcast (or Webcast) receiver program, a technology which is usually controlled by the broadcaster, can thus be completely separated from the recorder program of the present invention. The invention consists of a digital content recorder which is interposed between the Webcast receiver and the hardware (or the combined hardware and software) of the receiving computer or device. For instance, the digital content recorder can be inserted between the Internet broadcast receiver program and the audio sound card drivers and/or video drivers of the receiving computer. Even if the contents are encrypted at the broadcast end, the digital recorder can be inserted following the decryption process, wherever that process resides. The digital recorder receives a content stream from the Internet broadcast receiver and searches that stream for specific broadcast material, not by using textually-oriented keywords, but by using templates, advantageously multi-media content pattern matching templates.

The identification of the content can be accomplished by comparing the received content against a catalog of known patterns of existing content. There exists prior art for using some pattern/template of an audio file to identify such a file, to identify the song and the artist. This scheme was implemented by some of the file sharing services to try and identify copyrighted material. This technology has also been termed “fingerprinting”. An example of the commercialization of this technology can be found in http://www.idioma.co.il/Products/Products.htm.

This invention is a method and a system for recording content for later playback, where the content is recognized by the recording process without the need for a program guide or a text label on the contents. Advantageously, the content is recognized at the time it is being recorded, but the content items can be stored for future recognition, which is considered to still be part of the recordation process for the content item. The novelty of this invention is that this system and method allows a user to archive selected broadcast material for later viewing or listening, without the need for a program guide or explicit content labels on the broadcast material. A further novelty of this invention is the use of content templates together with a template matching algorithm to search a digital stream for content which is desired for the purpose of personal archival of the material for use at a later time.

The Internet content broadcaster streams a continuous stream of program content from the server to the client device's Internet content receiver. When a match is found between the content material being searched for and the content material which is being broadcast, the audio receiver stores this content to a storage location from which the found contents can be later retrieved. Thus, the content item is identified using its own content. The audio receiver labels the material with a content label or identifier such as a song name or a descriptive attribute related to the match criterion. The content identifier is therefore indicative of the content item it is associated with, whether the identifier directly includes the information or, or example, consists of a number reference to a list containing the information.

This technology is not only usable for recording audio data, it can also be used to record other types of data, such as multi-media information, including video broadcast material. In the case of video material, there is a much harder challenge in matching the received material to the stored template libraries to identify the material, but it is feasible.

The present invention uses an audio recorder program or an audio-visual recorder program which is independent of the program which receives the Internet broadcast. For instance, the program can be inserted after the Webcast receiver and before the information is sent to the computer's audio and/or video drivers. The following description for illustration purposes is more specifically worded to apply to the receipt of an audio program, but it can be generalized to an analogous description of a multi-media program reception.

The audio receiver program of this invention captures content information into a storage location—either in main RAM memory or on disk, which serves as a buffer of the content. Subsequently, a search process executes against the buffered content in real time or non-real time to compare the contents being received against fingerprint templates of the content. When a match is found, the contents are labeled and moved to a computer storage location from where they can be later retrieved.

The content can be matched in its entirety, meaning that the template could have useful information about matching the entire length of the media selection being searched for. A more efficient solution would be for the templates to consist of signature or fingerprint information which only identify a section of the contents. This limits the amount of processing that needs to be done to identify each stream, reducing the load on the computer doing the search. Once a content selection is identified, exact matching of beginning and ending patterns can be used to discover the beginning and end of the selection. Alternatively, techniques can be used to discover heuristically the beginning and end of the selection. Some examples of the heuristics used could be parameters such as known content length, silence gaps between content selections, or other explicit beginning/end markers.

The templates can be stored on the local computer or they can be distributed to a central location, where they can be easily updated and where they can be used to provide a content matching “service” to the universe of client receivers/recorders.

A preferred embodiment of the invention is as follows.

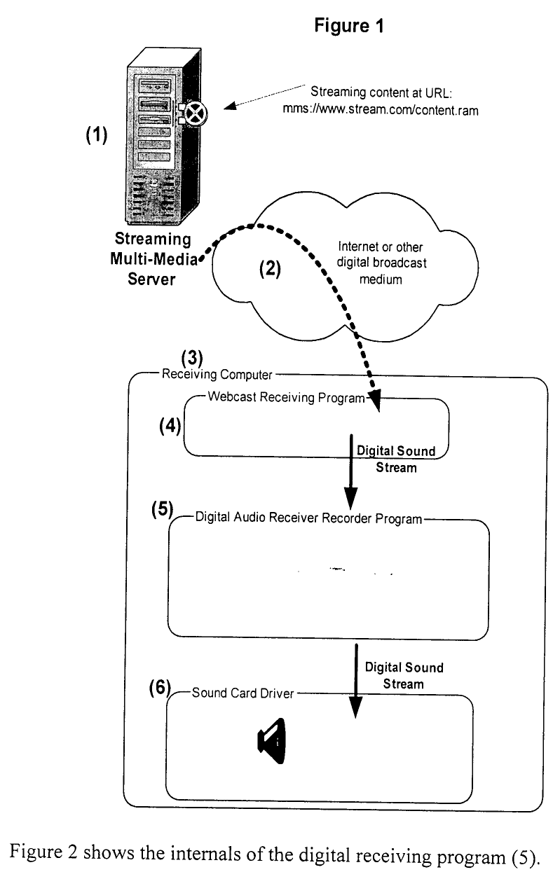

With reference to FIG. 1, an Internet streaming multi-media broadcast server 1 is set up to broadcast streaming audio content. This broadcaster is associated with a URL, such as mms://www.stream.com/content.ram. The contents are streamed through the Internet or other digital transmission medium 2. A receiving computer 3 is set up to receive the streaming content, using the Webcast receiver 4 associated with the broadcast service 1. Normally, the Webcast receiver 4 sends its output directly to the sound driver for the sound card 6. However, in accordance with the present invention, the Digital audio receiver/recorder 5 is inserted to process the audio output from the Internet Webcast receiver 4.

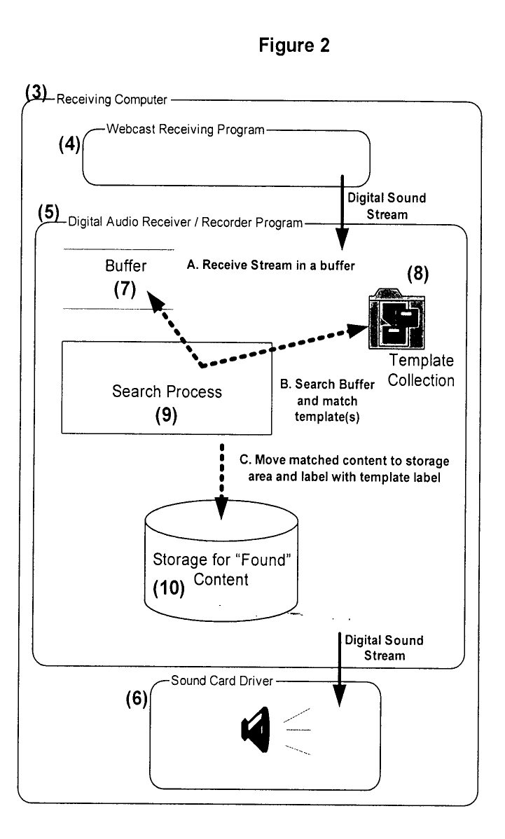

FIG. 2 shows the operation of the Digital Audio Recorder Program 5. First, the Digital Audio Receiver Recorder program 5 receives the audio stream. In this example, the stream consists of a audio encoded in PCM format, which is a widely used standard digital audio encoding. However, any recognizable format can be used. The audio receiver may leave the audio in its present form or process it, and sends this audio stream to a temporary buffer 7.

A collection of templates are loaded into the template storage 8 which describe the content that is being searched for. These templates contain matching criteria for content selections such as songs or multi-media content. The full template collection may also be stored on a central server and retrieved over the Internet, and just the active templates being searched for may be retrieved onto the local machine. A search process 9 examines the contents of the buffer 7 and uses a collection of active content templates stored in storage 8 to match with the contents of the buffer. When a template match is discovered, the search process identifies the beginning and end of the selection. This identification of beginning and end could use silence periods combined with beginning/ending templates. The search process 9 then copies the matched selection to an area of memory or on disk associated with the “found” content 10, and labels the contents with the information found in the template label. After the contents of the buffer 7 have been searched and the content of choice has been archived to area 10, the searched part of the buffer 7can be discarded or over-written, and the buffer 7 continues to be searched for new material.

The three basic steps outlined in FIG. 1 and FIG. 2 are:
1. The receiver process 5 receives the audio stream in a buffer 7.
2. A search process 9 searches the buffer 7 to attempt to match the contents against the templates stored in storage 8.
3. Found content is moved to a storage area 10 and labeled with the template label associated with it.

An alternate embodiment of this invention is to store the content matching templates entirely on a remote server, instead of in template storage 8. In this case, the search process 9 sends to the remote server a “sample” of the unknown media clip which contains the fingerprint, and the search is done on the remote server to match the unknown fingerprint with the database of templates. The remote server returns with an identification of the media clip, and the search process 9 uses this returned identity to label the clip in the archive 10.

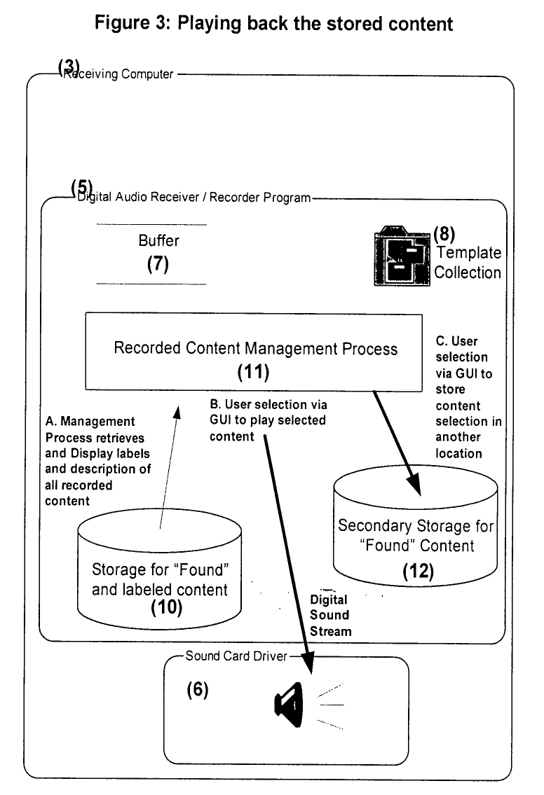

FIG. 3 shows an embodiment of the method and system for practicing a content management function after content is recorded by the digital recorder. In a step labeled Step A, a recorded content management process 11 retrieves all (or a specified subset of) the content labels from the content storage location and displays each content selection in a Graphical User Interface (GUI) window. The user can select one of the content selections and choose the “playback” function, labeled Step B. When Step B is optionally selected, the content management process (11) retrieves the selected content and sends this information to the Digital sound system 6 for playback through the computer speakers.

In a separate optionally selectable Step C, the content management process 11 prompts the user to enter the location of a secondary storage location for the content, such as the secondary storage location 12 in FIG. 3. When the user enters the secondary storage location, the content management process 11 stores the content item therein.

A preferred embodiment of this invention would have more options than just these two listed, such as changing the format of the content, or manipulating the content in other ways which are known to those skilled in the art of building content management software.

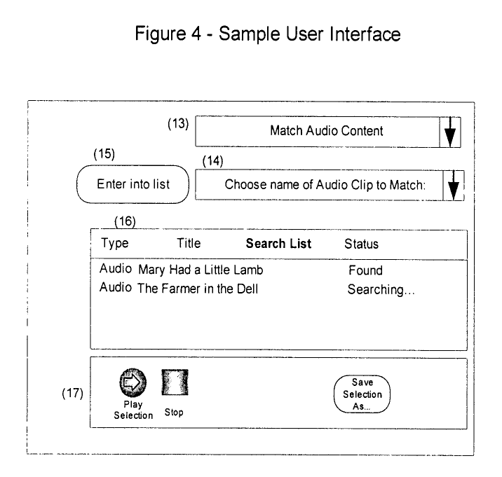

FIG. 4 shows an embodiment of an advantageous user interface 18 for selecting content to be recorded, as well as for playing back or saving that content after it has been recorded. Selection button 13 chooses the type of media to be searched for and recorded, and selection button 14 chooses the title of the content from a list of available templates. Although this figure shows a simple drop down button list for title selection, a different embodiment of the user interface could have a richer selection interface, where content can be selected from different classifications including artist name, genre, style, etc. Button 15 enters the selection currently displayed in drop down button 14 into the Search List 16. The user interface 18 advantageously insures that multiple copies of the same selection cannot be entered into the Search List 16. Search List 16 also displays the Content Type (such as “Audio” or “Video”) and the status of the selection (such as “Found” or “Searching . . . ”). The desired content selection is then searched for based upon the identifier stored in association with that item. When a content selection has the status of “Found”, it may be highlighted in the Search List 16 by selecting that search item. After highlighting the “Found” content item it may be manipulated using the panel of buttons 17, whereby the contents can be played or saved to secondary storage, as described in connection with FIG. 3.

This invention can be embodied in many forms. In a first example, it may be embodied in an application which captures content without any limitations (i.e. it captures all content which is received by the Webcast receiver program), identifies the content, and labels the content for later playback. Another embodiment of the invention is for the user to specify in advance by name a specific program content which the user wishes to play back at a later time. The search process is then made significantly easier, because there are a finite number of templates which need to be matched to the received content. Furthermore, the application can discard all content that does not conform to the search criteria, and archive for later play back only the content which has been specified.

It will be apparent to those skilled in the art that the foregoing description is for illustrative purposes only, and that various changes and modifications can be made to the present invention without departing from the overall spirit and scope of the present invention. Thus, while the present invention has been described with reference to the foregoing embodiments, changes and variations may be made therein which fall within the scope of the appended claims, and the full extent of the present invention is defined and limited only by the claims.

1. A system for recording selected broadcasted audio and/or video content for later playback, comprising:
a receiver for receiving, in a receiving process, a data stream that has been broadcast from a program source, the stream including a plurality of content items; and
a recorder, connected to receive the data stream from said receiver, for recording, in a recording process, at least one of the content items for later playback,
wherein, for each content item recorded by said recorder, said recording process uses a content of that content item to identify that content item as part of the process of its recordation and stores a respective item identifier indicative of the respective content for that content item.

2. The system of claim 1, wherein said recorder is recorder software installed in said system.

3. The system of claim 2, further comprising hardware for playing back content items, wherein said recorder software is interposed between said receiver and said hardware.

4. The system of claim 1, wherein any recorded content item is selectable for playback based upon its respective item identifier independently of any other recorded content item.

5. The system of claim 1, wherein said recording process is independent of said receiving process.

6. The system of claim 1, wherein said recording process uses template matching of the content of the content item to identify the content item.

7. A system for recording selected broadcasted audio and/or video content for later playback, comprising:
a receiver for receiving, in a receiving process, a data stream that has been webcast from a server, the stream including a plurality of content items; and
a recorder, connected to receive the data stream from said receiver, for recording, in a recording process independent of said receiving process, at least one of the content items for later playback,
wherein, for each content item recorded by said recorder, said recording process uses a content of that content item to identify that content item and stores a respective item identifier indicative of the respective content for that content item

8. The system of claim 7, wherein any recorded content item is selectable for playback based upon its respective item identifier independently of any other recorded content item.

9. The system of claim 7, wherein said recorder is recorder software installed in said system.

10. The system of claim 9, further comprising hardware for playing back content items, wherein said recorder software is interposed between said receiver and said hardware.

11. The system of claim 7, wherein said recording process identifies each one of the recorded content items by template matching.

12. The system of claim 1 1, wherein said template matching includes digital fingerprint content matching.

13. The system of claim 1 1, wherein a plurality of templates are stored, each template being indicative of a desired content item,
wherein said receiver receives the data stream and stores the content items therein in buffer memory; and
wherein said recorder searches said buffer memory to match content items stored therein to said templates such that, if a stored content item matches one of said templates, that content item is identified and is recorded by said recorder.

14. The system of claim 13, wherein each template has a respective template identifier stored in association therewith, and wherein each content item matched to a respective template receives an item identifier corresponding to the respective template identifier.

15. The system of claim 1 1, wherein a plurality of sets of templates are stored, each set of templates including a start template indicative of a start of a desired content item and an end template indicative of an end of that desired content item;
wherein said receiver receives the data stream and stores the content items therein in buffer memory; and
wherein said recorder searches said buffer memory to match content items stored therein to said sets of templates such that, if a stored content item matches one of said sets of templates, that content item is identified and is recorded by said recorder.

16. The system of claim 7, wherein said recorder uses timing information indicative of a duration of a desired content item to identify that content item in the data stream.

17. The system of claim 7, wherein said recorder uses designation information designating selected ones of the content items in the data stream to record only those selected content items and to not record any other content items in the data stream.

18. The system of claim 17, wherein the designation information is input to said apparatus by a user input.

19. The system of claim 7, wherein said recording process uses template matching of the content of the content item to identify the content item.

20. A method for recording selected broadcasted audio and/or video content for later playback, where a receiver receives, in a receiving process, a data stream that has been broadcast from a program source, the stream including a plurality of content items; said method comprising the steps of:
receiving the data stream from the receiver;
recording, in a recording process, at least one of the content items for later playback,
for each content item recorded in said recording step, identifying that content item as part of its recordation by using a content of that content item; and
storing a respective item identifier indicative of that content item for that content item.

21. The method of claim 20, wherein the recording process is independent of the receiving process.

22. A method for recording selected broadcasted audio and/or video content for later playback, where a receiver receives, in a receiving process, a data stream that has been webcast from a server, the stream including a plurality of content items; said method comprising the steps of:
receiving the data stream from the receiver;
recording, in a recording process independent of the receiving process, at least one of the content items for later playback,
for each content item recorded in said recording step, identifying that content item as part of its recordation by using a content of that content item; and
storing a respective item identifier indicative of that content item for that content item.
